(19) United States
(12) Patent Application Publication
(10) Pub. No.: US 2007/0038330 A1
(43) Pub. Date: Feb. 15, 2007

(54) Method and apparatus for controlling a dispensing apparatus for dispensing medication

(76) Inventor: Michael Hennessy Sullivan, Worcestershire (GB)

Correspondence Address: HOFFMAN WARNICK & D'ALESSANDRO, LLC, 75 STATE STREET, 14TH FLOOR, ALBANY, NY, 12207, US

(21) Appl. No.: 10/546,955

(22) PCT Filed: Feb. 25, 2004
(86) PCT No.: PCT/GB04/00747

§ 371 Date: Jun. 30, 2006

(30) Foreign Application Priority Data
Feb. 25, 2003 (GB) 0304261.1

(51) Int. Cl. G07C 9/00

(52) U.S. Cl. 700/237

(57) ABSTRACT

A system for controlling a dispensing apparatus and for monitoring one or more biometric properties of a user comprises a docking station (10) and one or more devices (6) for measuring a biometric property of a user. The devices (6) are couplable to the docking station (10) to provide information of the measured biometric property to the docking station (10). The docking station (10) is arranged to process the received information and control the dispensation of medication in response thereto depending on the measured biometric property information. There is also disclosed a method for monitoring one or more biometric properties of a user and for controlling the dispensation of medication thereto.

### FIELD OF THE INVENTION

The present invention relates to systems and methods for controlling a dispensing apparatus and preferably for monitoring one or more biometric properties of a user and controlling a dispensation apparatus in response to measured biometric properties. The methods and apparatus of the present invention have particular application in controlling medication dispensing devices where it is desired to monitor the use, consumption and/or effect of dosages.

### BACKGROUND OF THE INVENTION

Considerable problems are known to exist in patient healthcare programs arising from lack of patient compliance with medical treatment regimens, for example, failure to take the correct dose, failure to take doses at the correct time and cessation of treatment prematurely. The present invention seeks to address these problems by enabling an improvement in the quality of care offered to patients to be achieved. The applicants have appreciated that it would be desirable to provide a system and method by which the patient's reaction to a medication may be monitored remotely and the dispensation of medication may be controlled remotely, thereby relieving the patient of the sole responsibility for the correct administration of doses of medication and the variation of dosage amounts in a treatment regimen.

### SUMMARY OF THE INVENTION

According to a first aspect of the present invention there is provided a system for controlling a dispensing apparatus, the system comprising:
a docking station; and
one or more devices for measuring a biometric property reading to determine biometric property information;
the one or more devices being couplable to the docking station to provide the biometric property information to the docking station;
wherein the docking station is arranged and/or programmed to process the information received from the one or more devices and to control a dispensing apparatus in response thereto depending on the biometric property information.

According to a second aspect of the invention there is provided a system for monitoring one or more biometric properties of a user and for controlling the dispensation of a product thereto, comprising a docking station, and one or more devices for measuring a biometric property of a user, the one or more devices being couplable to the docking station to provide information of the measured biometric property to the docking station, wherein the docking station is arranged and/or programmed to process the information received by the docking station from the one or more devices and to control the dispensation of the product from a dispensing apparatus in response thereto depending on the measured biometric property information.

According to a third aspect of the present invention there is provided a method for controlling a product dispensing apparatus, the method comprising the steps of:
providing one or more devices for measuring a biometric property to obtain a biometric property reading;
coupling a docking station to the one or more devices;
transferring information associated with the measured biometric property reading from the one or more devices to the docking station;
processing in the docking station the information received from the one or more devices; and
controlling a dispensing apparatus in response to the processing of the information depending on the measured biometric property information.

According to a fourth aspect of the present invention there is provided a method for monitoring one or more biometric properties of a user and for controlling the dispensation of medication thereto, comprising:
providing one or more devices to measure a biometric property of a user to obtain biometric property reading information;
providing a docking station;
coupling the docking station to the one or more devices to provide information of the measured biometric property to the docking station; and
arranging and/or programming the docking station to process the received information and control the dispensation of medication in response thereto depending on the measured biometric property information.

According to a fifth aspect of the present invention there is provided a method for monitoring one or more biometric properties of a user and for controlling the dispensation of medication thereto, comprising:
measuring a biometric property of a user using one or more devices to obtain measured biometric property reading information;
coupling a docking station to the one or more devices;
transferring the measured biometric property reading information from the one or more devices to the docking station;
processing the measured biometric property reading information; and
controlling a medication dispensing apparatus in response to the processing of the information depending on the biometric property information.

According to a sixth aspect of the present invention there is provided a method for monitoring one or more biometric properties of a user and for controlling the dispensation of medication thereto, comprising providing the system of the type defined above.

The system preferably also comprises a medication device for dispensing medication to the user, the medication device being couplable to the docking station and being arranged to receive data and/or commands from the docking station for controlling the operation of the medication device.

Aspects and features of the invention are set forth in the claims following the description.

### BRIEF DESCRIPTION OF THE DRAWINGS

Embodiments of the present invention will now be described by way of example with reference to the accompanying drawings in which:

FIG. 1 is a block diagram showing components of an embodiment of a system according to an embodiment of the invention;

FIGS. 2a and 2b are elevations of a spirometer mounted on a docking station in accordance with an embodiment of the invention;

FIG. 2c is a projection of a spirometer mounted on a docking station in accordance with an embodiment of the invention;

FIGS. 3a and 3b are elevations of a pulse monitor mounted on a docking station in accordance with an embodiment of the invention;

FIG. 3c is a projection of a pulse monitor mounted on a docking station in accordance with an embodiment of the invention;

FIGS. 4a and 4b are elevations of an optical scanner mounted on a docking station in accordance with an embodiment of the invention;

FIG. 4c is a projection of an optical scanner mounted on a docking station in accordance with an embodiment of the invention;

FIGS. 5a and 5b are elevations of a stethoscope mounted on a docking station in accordance with an embodiment of the invention;

FIG. 5c is a projection of a stethoscope mounted on a docking station in accordance with an embodiment of the invention; and

FIGS. 6a-d are schematic elevations of various modules for use in accordance with embodiments of the invention.

### DESCRIPTION OF PREFERRED EMBODIMENTS

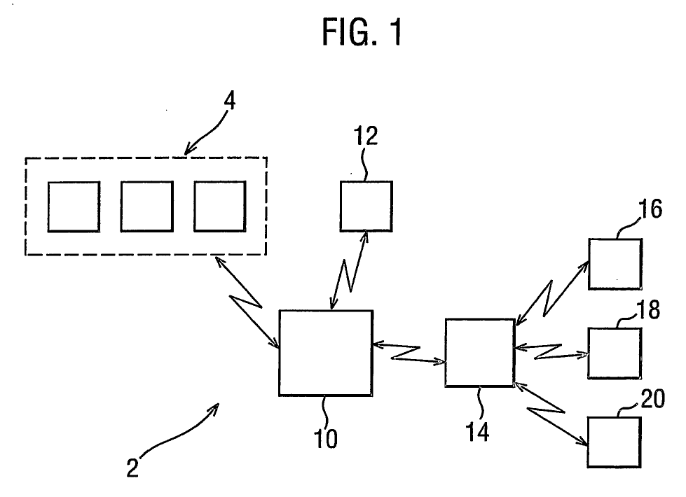

FIG. 1 illustrates a healthcare management system 2 arranged in accordance with an embodiment of the invention.

The system 2 includes a plurality of interchangeable healthcare modules or devices 4, a docking station 10, a product dispensing device 12, and a public service network 14 through which the docking station 10 may be accessed by an authorised party having an interest in the data stored therein, such as a physician 16, a pharmacist 18, or other authorised parties 20 such as a drug company wishing to monitor the effects of drugs on users during clinical trials of new or existing drugs.

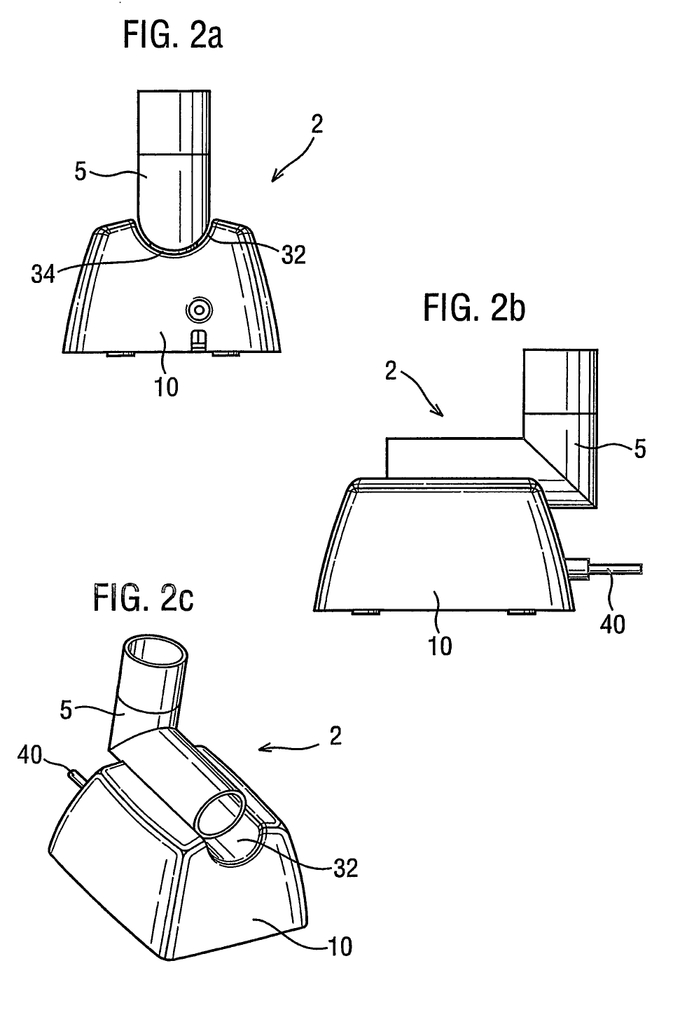

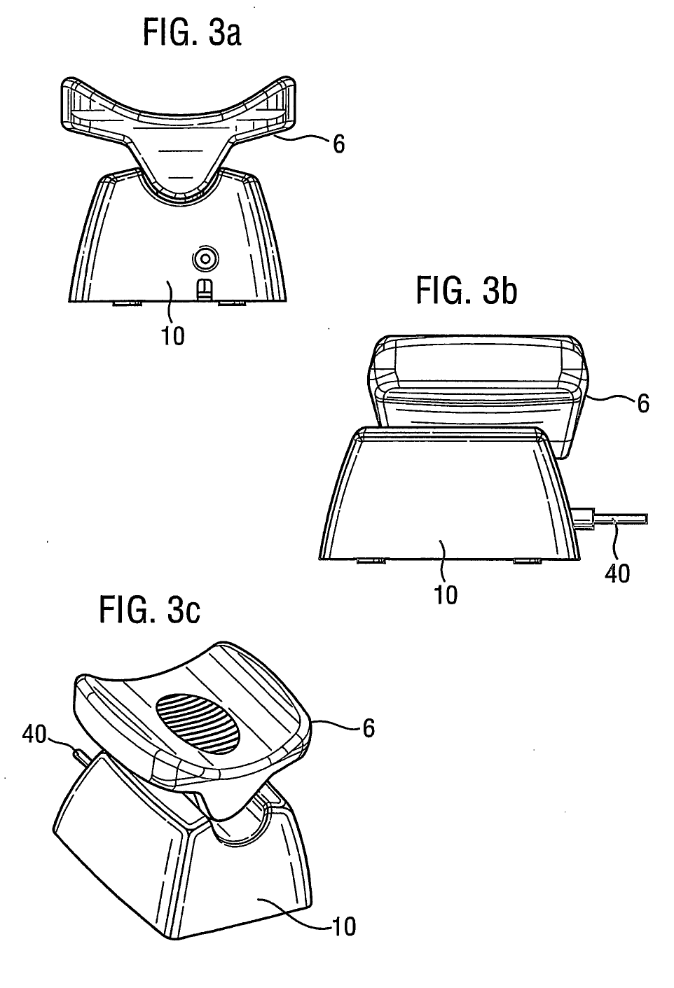

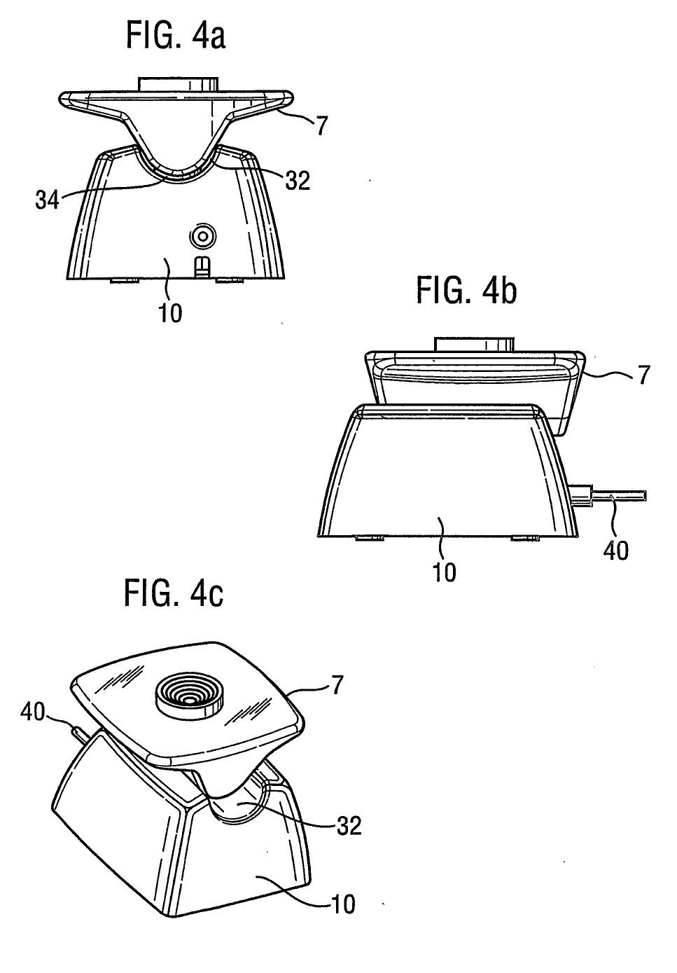

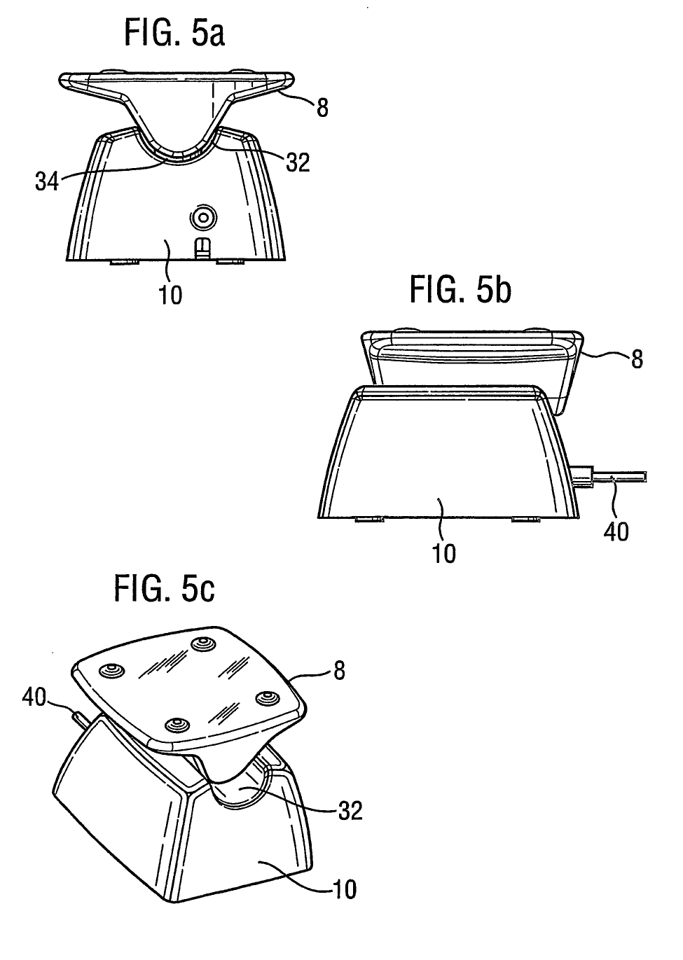

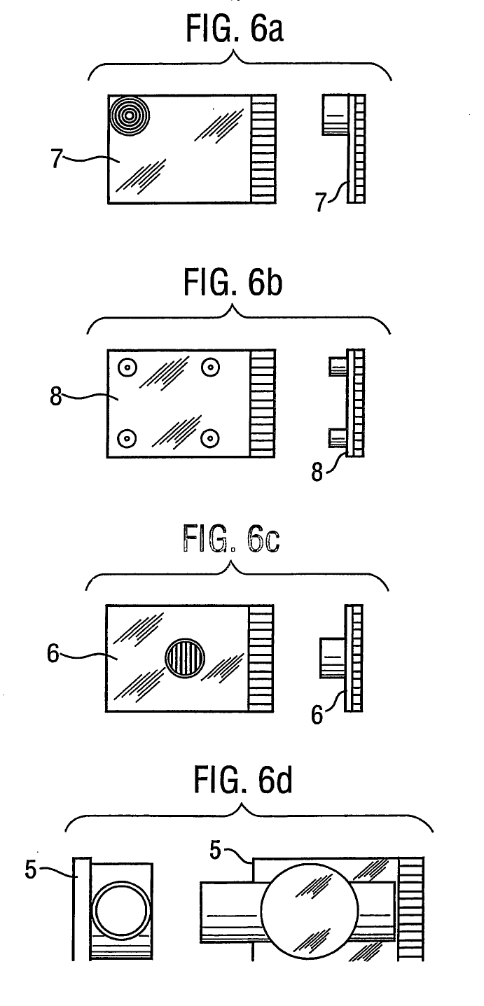

Various examples of possible healthcare modules 4 suitable for use with the systems and methods of the invention are illustrated in FIGS. 2a to 6d and may include a spirometer module as shown in FIGS. 2a-c and 6d, a pulse monitor module as shown in FIGS. 3a-c and 6c, an optical scanning module as shown in FIGS. 4a-c and 6a, a stethoscope module as shown in FIGS. 5a-c and 6b, a blood pressure monitor (not shown), a blood glucose level sensor (not shown), a thermometer (not shown), and a urine sampler (not shown).

The docking station 10 is couplable with the one or more healthcare modules 4, 5, 6, 7, 8 in a number of ways. For example, the docking station 10 may be connected to the devices 4 by means of a wireless communication, for example by an infrared link, by induction, or by another form of wireless communication, for example, a radio interface protocol such as the Bluetooth™ radio protocol. Alternatively, the coupling may be achieved by means of a physical connection such as a receiving channel 32 in the docking station 10 having one or more electrical contacts (not shown) for contacting corresponding contacts (not shown) on the module 4, 5, 6, 7, 8.

The docking station 10 may also include processing circuitry (not shown) for analysing data from the one or more healthcare modules 4, and may include a communications network connector for connecting the docking station 10 to a public service network 14 such as a telephone network or the Internet, or for connecting the docking station 10 to a local area network (LAN). Alternatively, the docking station may be couplable to the public service or a LAN wirelessly, for example via a radio interface protocol such as the Bluetooth™ radio protocol, or by means of other wireless connections, such as infrared or induction.

The processing circuitry within the docking station 10 may include a data processor, for example, an integrated circuit chip containing a microprocessor and a memory storage device such as a non-volatile memory in the form of, for example, a ROM or EEPROM. The memory storage device within the docking station 10 may be arranged to store data and processing algorithms.

The docking station 10 may also include a display (not shown), for example a liquid crystal display, for displaying information to the patient or user of the system 2.

The docking station 10 may contain an internal power source or a connector 40 for connecting the docking station 10 to the mains power supply.

The variety of interchangeable healthcare modules 4, 5, 6, 7, 8 may be provided for use with the docking station 10 to take various biometric readings from a user or a sample obtained from the user. For example, the spirometer illustrated in FIGS. 2a-c and 6d may be used for measuring lung capacity and other lung functions of the user. A pulse monitor module as shown in FIGS. 3a-c and 6c may be used for measuring the heart rate of the user; an optical scanning module as shown in FIGS. 4a-c and 6a may be used for measuring the condition of the eye of the patient, for example retinal discoloration, pupil dilation and other eye conditions which may indicate a user's response to a particular medication; a stethoscope module as shown in FIGS. 5a-c and 6b may be used for examining heart rhythms of the user, to check airway obstructions, and to analyse lung function and the like; a blood pressure monitor (not shown) may be used to measure the blood pressure of the user; a blood glucose level sensor (not shown) may be used to measure the glucose level in the blood of the user; a thermometer (not shown) may be used to measure the user's temperature; and a urine sampler (not shown) may be used to analyse the content of a user's urine sample.

The modules 4, 5, 6, 7, 8 may contain processing circuitry (not shown) to process the data from the biometric measurement and may include a memory storage device (not shown) to store the measurements which may be downloaded to the docking station 10.

The modules 4 may be disposable after use or may be reusable. The modules 4 may be formed in a plastic unit around the processing circuitry which is enclosed within the device, thereby sealing the circuitry within the device enabling the device to be cleaned without damage to the circuitry. Furthermore, the modules 4 may be ergonomically shaped to improve contact with the user, in use. Also, the modules 4 may be small in size, for example, around the size of a conventional credit card.

In a preferred embodiment, the modules 4 may be self-powered or powered from the docking station 10, for example, wirelessly such as by electromagnetic radiation and/or induction.

The system 2 may be used in the following method. The user applies the module 4 to the appropriate part of his body, as directed, or applies a sample from which the biometric property reading is to be taken, to the appropriate module 4. The module 4 takes a biometric measurement reading associated with the device being used, and records the result. The measured biometric data may be processed and/or stored in the module 4. At a convenient time, the module 4 is then mounted in or on, or is coupled to the docking station 10 and the stored data relating to the biometric measurement reading is transmitted to the docking station 10 where it may be processed, or further processed, as required, by the processing circuitry and may be stored in the memory storage device of the docking station 10.

In a preferred embodiment, at some point in time, the data stored in the docking station 10 may be made available via, for example, a public service network 14 to the remotely located authorised party 20, such as a physician 16, pharmacist 18 or another authorised party, for consideration and advice. Alternatively, or additionally, the processing circuitry in the docking station may compare the received biometric data with one or more algorithms stored in the memory of the docking station 10 for monitoring the user's condition or reaction to a particular medication.

A suitable dispensing device 12 for use with the system 2 embodying the present invention is, for example, a device of the type described in the applicant's co-pending International patent application no:GB02/003959. Such a device is couplable to a docking station 10 and may be arranged for one or two-way communication therewith to transfer data regarding dosage distribution of the dispensing device 12 being used by the particular user to the docking station 10. The data transmitted to the docking station 10 may be remotely accessible by an authorised third party, such as a physician, who may then relay instructions to the docking station 10 for controlling the dispensing device 12. The dispensing device 12 may be mounted in or on, or be otherwise connectable to the docking station 10, for example, wirelessly.

In a preferred embodiment of the system embodying the invention, the data obtained from the processed biometric data received by the docking station 10 from one or more of the modules 4 may be used to control the product or medication dispensed by the dispensing device 12 in the following manner.

The data obtained from the processed biometric data information received by the docking station 10 from the module 4 may be compared with stored data and/or algorithms stored in the docking station 10 relating to the patient's medical history and/or the expected performance of the product or medication being used. In the event of a detected abnormal result in the biometric property being measured in the context of the product or medication being used, the docking station 10 may instruct the dispensing device 12 to alter the dosage amount of product or medication dispensed therefrom when the docking station 10 is next in communication with the dispensing device 12. In a further embodiment, the physician 16 or other authorised persons 18, 20 may access the data stored in the docking station 10 and/or the dispensing device 12 and analyse it locally or assess it manually, and they may adjust the medication dosage remotely, storing the new dosage value in the docking station 10 which will transmit the revised dosage instructions to the dispensing device 12.

The docking station 10 may also be arranged to alert the authorised party 20, or patient, if urgent medical attention is required, or alert the party such as a pharmacist that the dispensing device 12 requires a refill, who may then arrange for refills to be supplied to the patient as and when necessary.

The docking station 10 could also be arranged to display an alarm either by an audible signal (e.g. a tone) and/or a visual signal such as a message to the patient instructing the patient, when medication or a biometric reading is due to be taken or, in the event of an abnormal result having been determined, instruct the patient not to medicate and/or inhibit the dispensing device from dispensing further product or medication.

Additional data such as the date, time and dosage of product or medication dispensed may be recorded and stored in either the dispensing device 12 or the docking station 10.

In a further preferred embodiment (not illustrated), biometric or treatment data may be recorded on a memory card, for example a smart card, which the patient could then take to the physician or pharmacy for further analysis.

It will be understood that the present disclosure is for the purpose of illustration only and variations may be made to the features described.

The embodiments of the present described above are particularly advantageous as they provide a system and method for the capture, processing and analysis of patient data and provide feedback to the patient directly, through the docking station 10 and/or the dispensing device 12. The docking station 10 or the patient's physician may analyse the data received and intervene to alter the patient's dosage regimen to adapt the dosage given to suit the patient's current state of health as determined by the biometric measurements taken by the system. In this way, a patient is receiving individual care and a dosage regimen tailored to that particular individual, thereby rendering the system more accessible to more people, as it is driven by biometric readings of individuals and is based upon the individual's reaction to the medication taken.

The systems and methods embodying the invention also enable a patient's physician to check that a patient is administering his medication in the correct manner and to intervene in the event of an irregularity or problem being detected. The physician may respond to the patient remotely through the docking station 10, essentially providing twenty-four hour intervention capability in the management of the patient's treatment program.

Furthermore, the systems and methods embodying the invention may be particularly useful in, for example, the clinical trials of new drugs where data captured from individuals testing the drugs may be captured from an early stage and analysed to build a history of patient reactions to certain drugs and amounts thereof. The systems and methods embodying the invention may therefore be used to monitor the product performance of new or existing drugs.

The data received or processed by the docking station 10 which is accessible by, for example, the physician 16, pharmacist 18 or other authorised party 20, is preferably encrypted to permit secure communication between the docking station 10 and the various parties. The data may be encrypted to various degrees to inhibit one or other party from accessing data which that party is not authorised to receive or view.

The various healthcare modules 4 may be disposable for economical and health reasons. These modules 4 are designed to be robust to withstand use and preferably are capable of gathering biometric data from the patient in approximately 10 second scans.

In a further preferred embodiment, the docking station 10 described above may be coupled into the home security system of a user or patient, for example, wirelessly or by means of a physical connector, and may use the communications platform used by the home security system to transmit and receive data and instructions. Such communications platforms may include the Internet or another public service network such as a telephone system. In this way, the home security system may be used, for example, to alert a third party of the condition of a user, such as an overdose condition, enabling quick action to be taken to attend to the user. The alert could, for example, be an alarm being activated or contact being made with the police or a security company.

The systems and methods embodying the invention may be applicable to humans and animals and are simple, low cost units which are small in size and easy to use.

1-47. (canceled)

48. A system for controlling a dispensing apparatus, the system comprising:
a docking station; and
one or more devices for measuring a biometric property reading to determine biometric property information;
the one or more devices being couplable to the docking station to provide the biometric property information to the docking station;
wherein the docking station is programmed to process the information received from the one or more devices and to control a dispensing apparatus in response thereto depending on the biometric property information.

49. A system for monitoring one or more biometric properties of a user and for controlling the dispensation of a product thereto, comprising a docking station, and one or more devices for measuring a biometric property of a user, the one or more devices being couplable to the docking station to provide information of the measured biometric property to the docking station, wherein the docking station is programmed to process the information received by the docking station from the one or more devices and to control the dispensation of the product from a dispensing apparatus in response thereto depending on the measured biometric property information.

50. A system according to claim 48, wherein the one or more devices are couplable to the docking station by means of a wireless connection.

51. A system according to claim 48, wherein the one or more devices are couplable to the docking station by infrared means, or by induction.

52. A system according to claim 48, wherein the one or more devices comprise one or more of a spirometer, a blood pressure monitor, a urine sampler, a pulse monitor, a stethoscope, a blood glucose sampler, an optical scanner, or a thermometer.

53. A system according to claim 48, wherein the biometric property measured is any one of pulse rate, lung capacity or function, blood glucose level, blood pressure, heart rhythm, urine content, temperature, pupil dilation, eye condition, or retinal information such as discoloration.

54. A system according to claim 48 wherein the docking station is arranged to transmit the received information to a remote location.

55. A system according to claim 54 wherein the docking station is arranged and/or programmed to transmit the received information over a public service network.

56. A system according to claim 54 wherein the docking station is arranged and/or programmed to transmit the received information over the telephone system, and/or the internet and/or another network.

57. A system according to claim 48, wherein the docking station is arranged and/or programmed to receive data and/or commands from a remote location.

58. A system according to claim 48, wherein the dispensing device is couplable to the docking station.

59. The system according to claim 48, wherein the dispensing device is arranged and/or programmed to receive data and/or commands from the docking station to control the operation of the dispensing device.

60. A system according to claim 48, wherein the dispensing device is arranged and/or programmed to transmit data to the docking station for processing.

61. A system according to claim 48, wherein the dispensing device is couplable to the docking station by means of a wireless connection.

62. A system according to claim 61, wherein the dispensing device is couplable to the docking station by means of induction, or infrared connection.

63. A system according to claim 48, wherein the one or more devices are arranged and/or programmed to store data and/or process biometric data.

64. A system according to claim 48, wherein the one or more devices are formed in a plastic unit around processing circuitry enclosed within the device for sealing the circuitry.

65. A system according to claim 48, wherein the docking station comprises a visual display for displaying data to the user.

66. A system according to claim 48, wherein the one or more devices are arranged to receive power from the docking station by physical connection to the docking station or by wireless communication with the docking station.

67. A system according to claim 48, wherein the docking station is arranged and/or programmed to transmit data to the dispensing device to control the amount of product dispensed therefrom in response to the biometric measurements made by the one or more devices.

68. A system according to claim 48, wherein the docking station is arranged and/or programmed to emit a signal to a user to alert the user to take a biometric measurement or to issue other commands to the user.

69. A system according to claim 68, wherein the docking station is arranged and/or programmed to emit an audible and/or a visual alert signal to a user.

70. A system according to claim 49, wherein the dispensing apparatus is a medication dispensing apparatus, and the product is a medication or a medicament.

71. A method for controlling a product dispensing apparatus, the method comprising the steps of:
providing one or more devices for measuring a biometric property to obtain a biometric property reading;
coupling a docking station to the one or more devices;
transferring information associated with the measured biometric property reading from the one or more devices to the docking station;
processing in the docking station the information received from the one or more devices; and
controlling a dispensing apparatus in response to the processing of the information depending on the measured biometric property information.

72. A method for monitoring one or more biometric properties of a user and for controlling the dispensation of medication thereto, comprising:
providing one or more devices to measure a biometric property of a user to obtain biometric property reading information;
providing a docking station;
coupling the docking station to the one or more devices to provide information of the measured biometric property to the docking station; and
programming the docking station to process the received information and control the dispensation of medication in response thereto depending on the measured biometric property information.

73. A method for monitoring one or more biometric properties of a user and for controlling the dispensation of medication thereto, comprising:
measuring a biometric property of a user using one or more devices to obtain measured biometric property reading information;
coupling a docking station to the one or more devices;
transferring the measured biometric property reading information from the one or more devices to the docking station;
processing the measured biometric property reading information; and
controlling a medication dispensing apparatus in response to the processing of the information depending on the biometric property information.

74. A method according to claim 71, wherein the step of coupling the docking station to the one or more devices comprises coupling the docking station to the one or more devices by means of a wireless connection.

75. A method according to claim 71, wherein the step of coupling the docking station to the one or more devices comprises coupling the docking station to the one or more devices by infrared means, and/or by induction.

76. A method according to claim 71, wherein the step of coupling the docking station to the one or more devices comprises coupling the docking station to one or more of a spirometer, a blood pressure monitor, a urine sampler, a pulse monitor, a stethoscope, a blood glucose sampler, an optical scanner, or a thermometer.

77. A method according to claim 71, wherein the biometric property measured is any one of pulse rate, lung capacity or function, blood glucose level, blood pressure, heart rhythm, urine content, temperature, pupil dilation, eye condition, or retinal information such as discoloration.

78. A method according to claim 71, further comprising the step of transmitting the biometric property reading information from the docking station to a remote location for processing.

79. A method according to claim 78 wherein the step of transmitting the information comprises transmitting the information over a public service network.

80. A method according to claim 79, wherein the step of transmitting the information comprises transmitting the information over the telephone system, and/or the internet.

81. A method according to claim 71, further comprising transmitting data and/or commands to the docking station from a remote location.

82. A method according to claim 71, further comprising coupling the dispensing apparatus to the docking station.

83. A method according to claim 71, further comprising transmitting data and/or commands from the docking station to the dispensing apparatus to control the operation of the dispensing apparatus.

84. A method according to claim 71, further comprising transmitting data from the dispensing apparatus to the docking station for processing.

85. A method according to claim 71, further comprising coupling the dispensing apparatus to the docking station by means of a wireless connection.

86. A method according to claim 85, wherein the step of coupling the dispensing apparatus to the docking station comprises coupling the dispensing apparatus to the docking station by means of induction, and/or infrared connection.

87. A method according to claim 73, further comprising storing data and/or processing biometric data in the one or more devices.

88. A method according to claim 73, further comprising forming the one or more devices in a plastic unit around processing circuitry enclosed within the one or more devices for sealing the circuitry.

89. A method according to claim 73, further comprising displaying data to a user by means of a visual display in or coupled to said docking station.

90. A method according to claim 73, further comprising supplying power to the one or more devices from the docking station by physical connection to the docking station or by wireless communication with the docking station.

91. A method according to claim 73, further comprising transmitting data from the docking station to the dispensing apparatus to control the amount of product dispensed therefrom in response to the biometric measurements made by the one or more devices.

92. A method according to claim 73, further comprising arranging and/or programming the docking station to emit a signal to alert a third party to take a biometric measurement or to issue other commands to the third party.

93. A method according to claim 92, wherein the step of arranging and/or programming the docking station to emit a signal comprises arranging and/or programming the docking station to emit an audible and/or a visual alert signal.

94. A method for monitoring one or more biometric properties of a user and for controlling the dispensation of medication thereto, comprising providing the system according to claim 48.

95. A method according to claim 72, wherein the step of coupling the docking station to the one or more devices comprises coupling the docking station to the one or more devices by means of a wireless connection.

96. A method according to claim 72, wherein the step of coupling the docking station to the one or more devices comprises coupling the docking station to the one or more devices by infrared means, and/or by induction.

97. A method according to claim 72, wherein the step of coupling the docking station to the one or more devices comprises coupling the docking station to one or more of a spirometer, a blood pressure monitor, a urine sampler, a pulse monitor, a stethoscope, a blood glucose sampler, an optical scanner, or a thermometer.

98. A method according to claim 72, wherein the biometric property measured is any one of pulse rate, lung capacity or function, blood glucose level, blood pressure, heart rhythm, urine content, temperature, pupil dilation, eye condition, or retinal information such as discolouration.

99. A method according to claim 72, further comprising the step of transmitting the biometric property reading information from the docking station to a remote location for processing.

100. A method according to claim 99, wherein the step of transmitting the information comprises transmitting the information over a public service network.

101. A method according to claim 100, wherein the step of transmitting the information comprises transmitting the information over the telephone system, and/or the internet.

102. A method according to claim 72, further comprising transmitting data and/or commands to the docking station from a remote location.

103. A method according to claim 72, further comprising transmitting data and/or commands from the docking station to the dispensing apparatus to control the operation of the dispensing apparatus.

104. A method according to claim 72, further comprising transmitting data from the dispensing apparatus to the docking station for processing.

105. A method according to claim 72, further comprising coupling the dispensing apparatus to the docking station by means of a wireless connection.

106. A method according to claim 105, wherein the step of coupling the dispensing apparatus to the docking station comprises coupling the dispensing apparatus to the docking station by means of induction, and/or infrared connection.

107. A method according to claim 73, wherein the step of coupling the docking station to the one or more devices comprises coupling the docking station to the one or more devices by means of a wireless connection.

108. A method according to claim 73, wherein the step of coupling the docking station to the one or more devices comprises coupling the docking station to the one or more devices by infrared means, and/or by induction.

109. A method according to claim 73, wherein the step of coupling the docking station to the one or more devices comprises coupling the docking station to one or more of a spirometer, a blood pressure monitor, a urine sampler, a pulse monitor, a stethoscope, a blood glucose sampler, an optical scanner, or a thermometer.

110. A method according to claim 73, wherein the biometric property measured is any one of pulse rate, lung capacity or function, blood glucose level, blood pressure, heart rhythm, urine content, temperature, pupil dilation, eye condition, or retinal information such as discolouration.

111. A method according to claim 73, further comprising the step of transmitting the biometric property reading information from the docking station to a remote location for processing.

112. A method according to claim 111, wherein the step of transmitting information comprises transmitting the information over a public service network.

113. A method according to claim 112, wherein the step of transmitting the information comprises transmitting the information over the telephone system, and/or the internet.

114. A method according to claim 73, further comprising transmitting data and/or commands to the docking station from a remote location.

115. A method according to claim 73, further comprising coupling the dispensing apparatus to the docking station.

116. A method according to claim 73, further comprising transmitting data and/or commands from the docking station to the dispensing apparatus to control the operation of the dispensing apparatus.

117. A method according to claim 73, further comprising transmitting data from the dispensing apparatus to the docking station for processing.

118. A method according to claim 73, further comprising coupling the dispensing apparatus to the docking station by means of a wireless connection.

119. A method according to claim 118, wherein the step of coupling the dispensing apparatus to the docking station comprises coupling the dispensing apparatus to the docking station by means of induction, and/or infrared connection.
